(19) United States
(12) Patent Application Publication
(10) Pub. No.: US 2009/0299546 A1
(43) Pub. Date: Dec. 3, 2009

(54) Dynamic-based method of estimating the absolute roll angle of a vehicle body

(76) Inventors: Aleksander B. Hac, Dayton, OH (US); Daniel Sygnarowicz, Wojnicz (PL)

Correspondence Address: DELPHI TECHNOLOGIES, INC., M/C 480-410-202, PO BOX 5052, TROY, MI, 48007, US

(21) Appl. No.: 12/154,909

(22) Filed: May 28, 2008

(51) Int. Cl. B60W 30/04; B60W 40/10

(52) U.S. Cl. 701/1

(57) ABSTRACT

The absolute roll angle of a vehicle body is estimated by blending two preliminary roll angle estimates based on their frequency so that the blended estimate continuously favors the more accurate of the preliminary roll angle estimates. A first preliminary roll angle estimate based on the measured roll rate is improved by initially compensating the measured roll rate for bias error using roll rate estimates inferred from other measured parameters. And a second preliminary roll angle estimate is determined according to the sum of the road bank angle and the relative roll angle. The blended estimate is used to estimate the actual lateral acceleration, the lateral velocity and side-slip angle of the vehicle, which are used in rollover detection and other various other control applications.

### TECHNICAL FIELD

The present invention relates to estimation of the absolute roll angle of a vehicle body for side airbag deployment and/or brake control, and more particularly to an improved dynamic-based estimation method.

### BACKGROUND OF THE INVENTION

A number of vehicular control systems including vehicle stability control (VSC) systems and rollover detection/prevention systems utilize various sensed parameters to estimate the absolute roll angle of the vehicle body—that is, the angle of rotation of the vehicle body about its longitudinal axis relative to the level ground plane. In addition, knowledge of absolute roll angle is required to fully compensate measured lateral accelerometer for the effects of gravity when the vehicle body is inclined relative to the level ground plane.

In general, the absolute roll angle of a vehicle must be estimated or inferred because it cannot be measured directly in a cost effective manner. Ideally, it would be possible to determine the absolute roll angle by simply integrating the output of a roll rate sensor, and in fact most vehicles equipped with VSC and/or rollover detection/prevention systems have at least one roll rate sensor. However, the output of a typical roll rate sensor includes some DC bias or offset that would be integrated along with the portion of the output actually due to roll rate. For this reason, many systems attempt to remove the sensor bias prior to integration. As disclosed in the U.S. Pat. No. 6,542,792 to Schubert et al., for example, the roll rate sensor output can be dead-banded and high-pass filtered prior to integration. While these techniques can be useful under highly transient conditions where the actual roll rate signal is relatively high, they can result in severe under-estimation of roll angle in slow or nearly steady-state maneuvers where it is not possible to separate the bias from the portion of the sensor output actually due to roll rate.

A more effective approach, disclosed in the U.S. Pat. Nos. 6,292,759 and 6,678,631 to Schiffmann, is to form an additional estimate of roll angle that is particularly reliable in slow or nearly steady-state maneuvers, and blend the two roll angle estimates based on specified operating conditions of the vehicle to form the roll angle estimate that is supplied to the VSC and/or rollover detectior/prevention systems. In the Shiffmann patents, the additional estimate of roll angle is based on vehicle acceleration measurements, and a coefficient used to blend the two roll angle estimates has a nominal value except under rough-road or airborne driving conditions during which the coefficient is changed to take into account only the estimate based on the measured roll rate.

Of course, any of the above-mentioned approaches are only as good as the individual roll angle estimates. For example, the additional roll angle estimate used in the above-mentioned Schiffmann patents tends to be inaccurate during turning maneuvers. Accordingly, what is needed is a way of forming a more accurate estimate of absolute roll angle.

### SUMMARY OF THE INVENTION

The present invention is directed to an improved method of estimating the absolute roll angle of a vehicle body under any operating condition, including normal driving, emergency maneuvers, driving on banked roads and near rollover situations. The roll angle estimate is based on typically sensed parameters, including roll rate, lateral acceleration, yaw rate, vehicle speed, and optionally, steering angle and longitudinal acceleration. Roll rate sensor bias is identified by comparing the sensed roll rate with roll rate estimates inferred from other measured parameters for fast and accurate removal of the bias. A first preliminary estimate of roll angle is determined according to the sum of the road bank angle and the body roll angle relative to the road. The road bank angle is estimated based on a kinematic relationship involving lateral acceleration, yaw rate, vehicle speed, and steering wheel angle, and the roll angle relative to the road is estimated based on lateral acceleration and the vehicle roll gain. The final or blended estimate of roll angle is then determined by blending the first preliminary estimate with a second preliminary estimate based on the bias-corrected measure of roll rate. In the blending process, the relative weighting between two preliminary roll angle estimates depends on their frequency so that the final estimate continuously favors the more accurate of the preliminary estimates. The blended estimate is used for several purposes, including estimating the lateral velocity and side-slip angle of the vehicle.

### BRIEF DESCRIPTION OF THE DRAWINGS

FIG. 1 is a diagram of a vehicle during a cornering maneuver on a banked road;

FIG. 2 is a diagram of a system for the vehicle of FIG. 1, including a microprocessor-based controller for carrying out the method of this invention; and

FIG. 3 is a flow diagram representative of a software routine periodically executed by the microprocessor-based controller of FIG. 2 for carrying out the method of this invention.

### DESCRIPTION OF THE PREFERRED EMBODIMENT

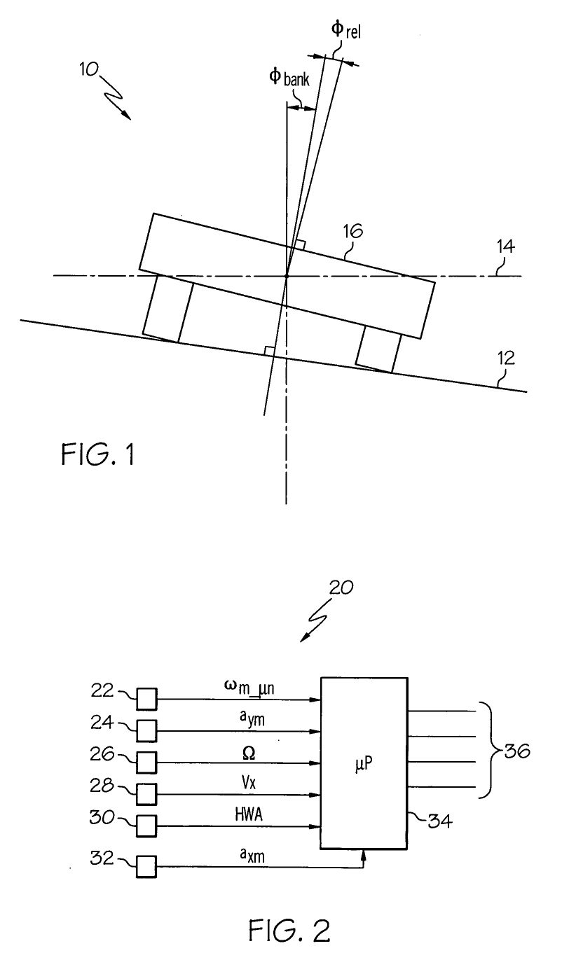

Referring to FIG. 1, the reference numeral 10 generally designates a vehicle being operated on a road surface 12. In the illustration, the road surface 12 is laterally inclined (i.e., banked) relative to the level ground plane 14 by an angle φ_{bank}. Additionally, the body 16 of vehicle 10 has a roll angle φᵣₑₗ relative to the road surface 12 due to suspension and tire compliance. The total or absolute roll angle of vehicle body 16, denoted herein as φₜₒₜ, can therefore be expressed as:

φₜₒₜ=φ_{bank}+φᵣₑₜ (1)

If the roll rate of vehicle 10 about its longitudinal axis is measured, an estimate φₑ_{_{ω}} the total roll angle φₜₒₜ can be determined in principle by integrating the measured roll rate, as follows:

$${φ}_{e ω} ( t ) = {\int }_{0}^{t} {ω}_{m} ( τ ) d τ \qquad ( 2 )$$

where t denotes time and ωₘ is the measured roll rate. Unfortunately, the output of a typical roll rate sensor includes some bias error that would be integrated along with the portion of the output actually due to roll rate. Thus, pure integration of the measured roll rate has infinite sensitivity to the bias error because the error is integrated over time. When dead-banding and high-pass (i.e., wash-out) filtering are used to compensate for the bias error, there is still a conflict between the immunity to bias and the ability to track slowly-varying (or constant) roll angles because the bias compensation also reduces the portion of the signal actually due to roll rate. As a result, a roll angle estimate based on roll rate integration is reasonably good during quick transient maneuvers, but less accurate during slow maneuvers or in nearly steady-state conditions when the roll angle changes slowly. As explained below, one aspect of the present invention is directed to an improved method of compensating for the bias error in a measured roll rate signal without substantially diminishing the portion of the signal actually due to roll rate.

An alternative way of determining the total roll angle φₜₒₜ is to sum individual estimates of bank angle bank and relative roll angle φᵣₑₗ in accordance with equation (1).

The relative roll angle φᵣₑₗ can be estimated as:

φᵣₑₗ=−R_{gain}a_{ym} (3)

where a_{ym} is the lateral acceleration measured at the vehicle's center-of-gravity, and R_{gain} is the roll gain of vehicle 10. The roll gain R_{gain} can be estimated for a given vehicle as a function of the total roll stiffness of the suspension and tires, the vehicle mass, and distance from the road surface 12 to the vehicle's center-of-gravity.

The bank angle φ_{bank} can be estimated based on the kinematic relationship between lateral acceleration a_{ym} and other measured parameters. Specifically, the lateral acceleration a_{ym} can be expressed in terms of the total roll angle φₜₒₜ as follows:

a_{ym}=\dot{v}_{y}+vₓΩ−g sin φₜₒₜ (4)

where v_{y} is the lateral velocity of vehicle center-of-gravity, vₓ is the vehicle longitudinal velocity, Ω is vehicle yaw rate, and g is the acceleration of gravity (9.806 m/s²). The sign convention used in equation (4) assumes that lateral acceleration a_{ym} and yaw rate Ω are positive in a right turn, but the roll angle φₜₒₜ due to the turning maneuver is negative. The same sign convention is used in equation (3).

In most instances, sin φₜₒₜ can be closely approximated by the sum (φᵣₑₗ+sin φ_{bank}) because φᵣₑₗ will be small (say, less than 7 degrees) and bank will not exceed 15 degrees. Hence, equation (4) can be reformulated as:

a_{ym}+gφᵣₑₗ=\dot{v}_{y}+vₓΩ−g sin φ_{bank} (5)

In equation (5), the term (\dot{v}_{y}+vₓΩ) is the cornering component of the measured lateral acceleration a_{ym}, and the term (−g sin φ_{bank}) is the bank angle component of a_{ym}, also referred to herein as bank acceleration a_{ybank}. Therefore, the term on the left side of the equation—that is, (a_{ym}+gφᵣₑₗ)—is the measured lateral acceleration compensated for the effect of relative roll angle φᵣₑₗ, also referred to herein as a_{ycomp}.

If the derivative of lateral velocity (i.e., \dot{v}_{y}) is relatively small, the bank acceleration a_{ybank} (that is, −g sin φ_{bank}) can be estimated by low-pass filtering the expression:

a_{ym}+gφᵣₑₗ−vₓΩ or a_{ycomp}−vₓΩ (6)

Thus, bank angle φ_{bank} can be estimated using equation (6) in a system where vₓ and Q are measured in addition to a_{ym}.

An advantage of estimating the total roll angle BOW as the sum of φ_{bank} and φᵣₑₗ per equation (1) is that φᵣₑₗ tends to be substantially larger than φ_{bank} in most driving conditions. This is significant because φᵣₑₗ is reasonably accurate in both steady-state and transient driving conditions, and this accuracy is reflected for the most part in the sum (φ_{bank}+φᵣₑₗ). Of course, in transient conditions on a significantly banked road, the estimation inaccuracy of φ_{bank} (due to the assumption that the derivative of lateral velocity is negligible) will also be reflected in the sum (φ_{bank}+φᵣₑₗ). Thus, the estimation of φₜₒₜ based on equation (1) tends to be reasonably accurate except under transient conditions on a significantly banked road.

In summary, the foregoing methods of estimating absolute roll angle each have significant limitations that limit their usefulness. As explained above, a roll angle estimate based on roll rate integration is reasonably good during quick transient maneuvers, but less accurate during slow maneuvers or in nearly steady-state conditions when the roll angle changes slowly due to inability to separate the bias error from the portion of the signal actually due to roll rate. On the other hand, the roll angle estimate based on the sum of φ_{bank} and φᵣₑₗ according to equation (1) is reasonably good during nearly steady-state or low frequency maneuvers, and even during quick maneuvers performed on level roads, but unreliable during quick transient maneuvers performed on banked roads or when roll angle is induced by road bumps, which usually elicit fairly quick transient responses.

It can be seen from the above that the two roll angle estimation methods are complementary in that conditions that produce an unreliable estimate from one estimation method produce an accurate estimate from the other estimation method, and vice versa. Accordingly, the method of this invention blends both estimates in such a manner that the blended roll angle estimate is always closer to the initial estimate that is more accurate.

FIG. 2 is a diagram of an electronic control system 20 installed in vehicle 10 for enhancing vehicle stability and occupant safety. For example, the system 20 may include a vehicle stability control (VSC) system for dynamically activating the vehicle brakes to enhance stability and reduce the likelihood of rollover, and a supplemental restraint system (SRS) for deploying occupant protection devices such as seat belt pretensioners and side curtain air bags in response to detection of an impending rollover event. System sensors include a roll rate sensor 22 responsive to the time rate of angular roll about the vehicle longitudinal axis, a lateral acceleration sensor 24 responsive to the vehicle acceleration along its lateral axis, a yaw rate sensor 26 responsive to the time rate of yaw motion about the vehicle yaw axis, and at least one wheel speed sensor 28 for estimating the vehicle velocity along its longitudinal axis. Optionally, the system 20 additionally includes a hand-wheel sensor 30 responsive to the vehicle steering angle and a longitudinal acceleration sensor 32 responsive to the vehicle acceleration along its longitudinal axis. In practice, ordinary VSC systems include most if not all of the above sensors. Output signals produced by the sensors 22-32 are supplied to a microprocessor-based controller 34 which samples and processes the measured signals, carries out various control algorithms, and produces outputs 36 for achieving condition-appropriate control responses such as brake activation and deployment of occupant restraints. Of course, the depicted arrangement is only illustrative; for example, the functionality of controller 34 may be performed by two or more individual controllers if desired.

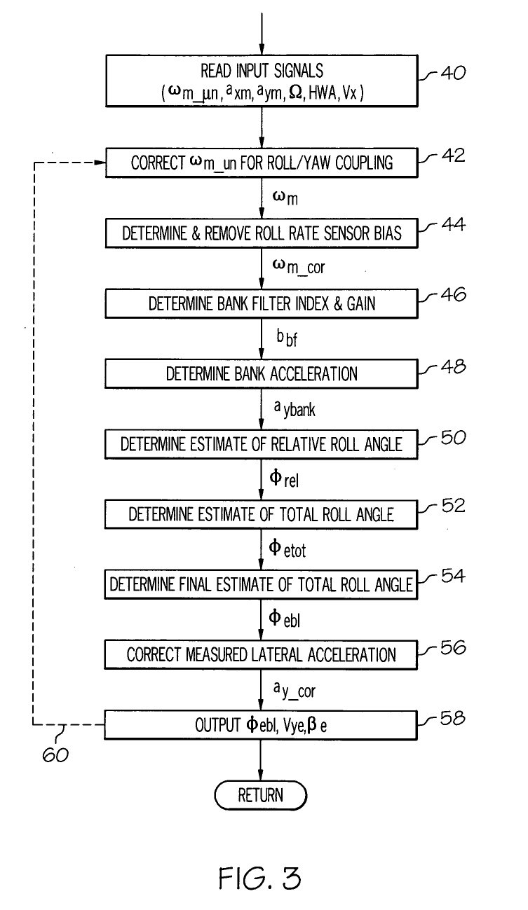

FIG. 3 depicts a flow diagram representative of a software routine periodically executed by the microprocessor-based controller 34 of FIG. 2 for carrying out the method of the present invention. The input signals read at block 40 of the flow diagram include measured uncompensated roll rate φₘ_{_{—}}ᵤₙ, measured lateral acceleration a_{ym}, yaw rate Ω, vehicle speed vₓ, and optionally, hand-wheel (steering) angle HWA and measured longitudinal acceleration aₓₘ. It is assumed for purposes of the present disclosure that the yaw rate Ω and lateral acceleration a_{ym} input signals have already been compensated for bias error, as is customarily done in VSC systems. Furthermore, it is assumed that all the input signals have been low-pass filtered to reduce the effect of measurement noise.

Block 42 pertains to systems that include a sensor 32 for measuring longitudinal acceleration aₓₘ, and functions to compensate the measured roll rate ωₘ_{_{—}}ᵤₙ for pitching of vehicle 10 with respect to the horizontal plane 14. Pitching motion affects the roll rate detected by sensor 22 due to cross coupling between the yaw rate and roll rate vectors when the vehicle longitudinal axis is inclined with respect to the horizontal plane 14. This occurs, for example, during driving on a spiral ramp. Under such conditions the vertical yaw rate vector has a component along the longitudinal (i.e. roll) axis, to which sensor 22 responds. This component is not due to change in roll angle and should be rejected before the roll rate signal is further processed. In general, the false component is equal to the product of the yaw rate Ω and the tangent of the pitch angle θ. The absolute pitch angle θ is estimated using the following kinematic relationship:

aₓₘ=\dot{v}ₓ−v_{y}Ω+g sin θ (7)

where aₓₘ is the measured longitudinal acceleration, \dot{v}ₓ is the time rate of change in longitudinal speed vₓ, v_{y} is the vehicle's side-slip or lateral velocity, Ω is the measured yaw rate, and g is the acceleration of gravity. Equation (7) can be rearranged to solve for pitch angle θ as follows:

$$θ = {sin}^{- 1} \frac{{a}_{xm} - {\dot{v}}_{x} = {v}_{y} Ω}{g} \qquad ( 8 )$$

The term \dot{v}ₓ is obtained by differentiating (i.e., high-pass filtering) the estimated vehicle speed vₓ. If the lateral velocity v_{y} is not available, the product (v_{y} Ω) can be ignored because it tends to be relatively small as a practical matter. However, it is also possible to use a roll angle estimate to estimate the lateral velocity v_{y}, and to feed that estimate back to the pitch angle calculation, as indicated by the dashed flow line 60. Also, the accuracy of the pitch angle calculation can be improved by magnitude limiting the numerator of the inverse-sine function to a predefined threshold such as 4 m/s². The magnitude-limited numerator is then low-pass filtered with, for example, a second-order filter of the form b_{nf}²/(s²+2ζb_{nf}+b_{nf}²), where b_{nf} is the undamped natural frequency of the filter and ζ is the damping ratio (example values are b_{nf}=3 rad/sec and ζ=0.7). Also, modifications in the pitch angle calculation may be made during special conditions such as heavy braking when the vehicle speed estimate vₓ may be inaccurate. In any event, the result of the calculation is an estimated pitch angle θₑ, which may be subjected to a narrow dead-zone to effectively ignore small pitch angle estimates. Of course, various other pitch angle estimation enhancements may be used, and additional sensors such as a pitch rate sensor can be used to estimate θ by integration.

Once the pitch angle estimate θₑ is determined, the measured roll rate is corrected by adding the product of the yaw rate Ω and the tangent of the pitch angle θₑ to the measured roll rate Ωₘ_{_{—}}^{un} to form the pitch-compensated roll rate Ωₘ as follows:

ωₘ=ωₘ_{_{—}}ᵤₙ+Ω tan θₑ (9)

Since in nearly all cases, the pitch angle de is less than 20° or so, equations (8) and (9) can be simplified by assuming that sin θ≅tan θ≅θ. And as mentioned above, the measured roll rate ωₘ_{_{—}}ᵤₙ can be used as the pitch-compensated roll rate ωₘ if the system 20 does not include the longitudinal acceleration sensor 32.

Block 44 is then executed to convert the roll rate signal ωₘ into a bias-compensated roll rate signal ωₘ_{_{—}}_{cor} suitable for integrating. In general, this is achieved by comparing ωₘ with two or more roll rate estimates obtained from other sensors during nearly steady-state driving to determine the bias, and then gradually removing the determined bias from ωₘ.

A first roll rate estimate ω_{eay} is obtained by using equation (3) to calculate a roll angle φ_{eay} corresponding to the measured lateral acceleration a_{ym}, and differentiating the result. However, a_{ym} is first low-pass filtered to reduce the effect of measurement noise. Preferably, the filter is a second-order filter of the form b_{nf}²/(s²+2ζb_{nf}+b_{nf}²), where b_{nf} is the un-damped natural frequency of the filter and ζ is the damping ratio (example values are b_{nf}=20 rad/s and ζ=0.7). And differentiation of the calculated roll angle φ_{eay} is achieved by passing φ_{eay} through a first-order high-pass filter of the form b_{f}s/(s+b_{f}), where b_{f} is the filter cut off frequency (an example value is b_{f}=20 rad/sec). This high-pass filter can be viewed as a combination of a differentiator, s, and a low-pass filter, b/(s+b).

A second roll rate estimate φₑₖ is obtained by using the kinematic relationship of equation (4) to calculate a roll angle φₑₖ and differentiating the result. The derivative of lateral velocity, \dot{v}_{y}, is neglected since near steady-state driving conditions are assumed. Accordingly, φₑₖ is given as:

$${φ}_{ek} = {sin}^{- 1} \frac{{( {v}_{x} Ω - {a}_{ym} )}_{filt}}{g} \qquad ( 10 )$$

As indicated in the above equation, the numerator (vₓΩ−a_{ym}) of the inverse sine function is also low-pass filtered, preferably with the same form of filter used for a_{ym} in the preceding paragraph. As a practical matter, the inverse sine function can be omitted since the calculation is only performed for small roll angles (less than 3° or so). Differentiation of the calculated roll angle trek to produce a corresponding roll rate ωₑₖ is achieved in the same way as described for roll angle φ_{eay} in the preceding paragraph.

Once the roll rate estimates ω_{eay} and ωₑₖ have been calculated, a number of tests are performed to determine their stability and reliability. First, the absolute value of each estimate must be below a threshold value for at least a predefined time on the order of 0.3-0.5 sec. Second, the absolute value of their difference (that is, |_{eay}−ωₑₖ|) must be below another smaller threshold value for at least a predefined time such as 0.3-0.5 sec. And finally, the absolute value of the difference between the measured lateral acceleration and the product of yaw rate and vehicle speed (that is, |a_{ym}−vₓΩ|) must be below a threshold value such as 1 m/sec² for at least a predefined time such as 0.3-0.5 sec. Instead requiring the conditions to be met for a predefined time period, it is sufficient to require that the signal magnitudes have a rate of change that is lower than a predefined rate.

When the above conditions are all satisfied, the roll rate estimates φ_{eay} and ωₑₖ are deemed to be sufficiently stable and reliable, and sufficiently close to each other, to be used for isolating the roll rate sensor bias error. In such a case, inconsistencies between the estimated roll rates and the measured roll rate are considered to be attributable to roll rate sensor bias error. First, the difference Δωₘ_{_{—}}_{ay} between the measured roll rate am and the estimated roll rate ω_{eay} is computed and limited in magnitude to a predefined value such as 0.14 rad/sec to form a limited difference Δωₘ_{_{—}}_{ay}_{_{—}}ₗᵢₘ. Then the roll rate sensor bias error ω_{bias} is calculated (and subsequently updated) using the following low-pass filter function:

ω_{bias}(tᵢ₊₁)=(1−bΔt)ω_{bias}(tᵢ)+bΔtΔωₘ_{_{—}}_{ay}_{_{—}}ₗᵢₘ(tᵢ) (11)

where tᵢ₊₁ denotes the current value, tᵢ denotes a previous value, b is the filter cut off frequency (0.3 rad/sec, for example), and Δt is the sampling period. The initial value of ω_{bias} (that is, ω_{bias} (t)) is either zero or the value of ω_{bias} from a previous driving cycle. The roll rate bias error ω_{bias} is periodically updated so long as the stability and reliability conditions are met, but updating is suspended when one or more of the specified conditions is not satisfied. As a practical matter, updating can be suspended by setting b=0 in equation (11) so that ω_{bias}(tᵢ₊₁)=ω_{bias}(tᵢ). Finally, the calculated bias error ω_{bias} is subtracted from the measured roll rate ωₘ, yielding the corrected roll rate ωₘ_{_{—}}_{cor}. And if desired, a narrow dead-band may be applied to ωₘ_{_{—}}_{cor} to minimize any remaining uncompensated bias.

The blocks 46 and 48 are then executed to estimate bank acceleration a_{ybank} by calculating a low-pass filtered version of expression (6) similar to the calculation of ω_{bias} in equation (11). Since expression (6) assumes that the derivative of lateral velocity is negligible, the block 46 first determines a bank filter index bfi that reflects the degree to which this assumption is correct, and the low-pass filter gain b_{bf} depends on the index bfi. In general, the index bfi has a value of one when vehicle 10 is in nearly steady-state condition in terms of yaw motion, and a value of zero when vehicle 10 is in a transient yaw maneuver. When bfi has a value of one, the filter gain b_{bf} is relatively high for rapid updating the bank acceleration estimate; but when bfi has a value of zero, the filter gain b_{bf} is relatively low for slow updating the bank acceleration estimate.

Three conditions are checked to determine whether vehicle 10 is in a nearly steady-state condition in terms of yaw motion. First, magnitude of the rate of change in hand wheel angle (HWA) must be below a threshold value such as 30 deg/sec²≅0.52 rad/sec. As a practical matter, rate of change in HWA can be obtained by passing HWA through a high-pass filter function of the form bs/(s+b) where s is the Laplace operand and b is the filter's cut off frequency. If the input HWA is not available, an alternate condition is that the rate of change of measured lateral acceleration a_{ym} must be below a threshold such as 5.0 m/sec³. Second, the magnitude of the product of vehicle speed and yaw rate (i.e., |vₓΩ|) must be below a threshold value such as 4 m/sec². And third, the magnitude of the rate of change of the product of vehicle speed and yaw rate (that is, |d(vₓΩ)/dt|) must be below a threshold such as 3 m/sec². Here again, the rate of change of the product vₓΩ can be obtained by passing vₓΩ through a high-pass filter function of the form bs/(s+b) where s is the Laplace operand and b is the filter's cut off frequency. If the three conditions are all satisfied for a specified time period such as 0.5 sec., vehicle 10 is deemed to be in a steady-state condition, and the bank filter index bfi is set to one to establish a relatively high filter gain b_{bf} such as 1.0 rad/sec. Otherwise, the bank filter index bfi is set to zero to establish a relatively low filter gain b_{bf} such as 0.25 rad/sec.

As explained above, the bank acceleration a_{ybank} is the component of the measured lateral acceleration a_{ym} due to bank angle φ_{bank}, and is equal to −g sin φ_{bank}. Also, a_{ycomp} is the measured lateral acceleration, compensated for the effect of relative roll angle φᵣₑₗ, and is equal to (a_{ym}+gφᵣₑₗ) In general, the bank acceleration a_{ybank} is estimated according to the difference between a_{ycomp} and the product vₓΩ, and then used to solve for bank angle φ_{bank}. In view of equation (3), a_{ycomp} can be expressed as:

a_{ycomp}=(1−gR_{gain})a_{ym} (12)

where R_{gain} is the roll gain of vehicle 10 in radians of roll angle per 1 m/sec² of lateral acceleration. The difference d_{avΩ} between a_{ycomp} and the product vₓΩ is magnitude limited to a value such as 5 m/sec², and the limited difference d_{avΩ}_{_{—}}ₗᵢₘ is then passed through a low-pass filter with the filter gain b_{bf} determined at block 46 to determine the bank acceleration ay_{bank}. The discrete-time form of the low-pass filter equation is given as:

a_{ybank}(tᵢ₊₁)=(1−b_{bf}Δt)a_{ybank}(tᵢ)+b_{bf}Δtd_{avΩ}_{_{—}}ₗᵢₘ(tᵢ₊₁) (13)

where tᵢ₊₁ denotes the current value, tᵢ denotes a previous value, and Δt is the sampling period. It will be noted that the filter gain term b_{bf} operates on the limited difference d_{avΩ}_{_{—}}ₗᵢₘ so that the filter is updated quickly during nearly steady-state conditions when b_{bf} is large (i.e., bfi=1) and slowly during transient maneuvers when b_{bf} is small (i.e., bfi=0). And once a_{ybank} is known, the corresponding bank angle estimate φ_{ebank} is determined according to:

$${φ}_{ebank} = {sin}^{- 1} ( \frac{- {a}_{ybank}}{g} ) \qquad ( 14 )$$

Block 50 then determines an estimate φₑᵣₑₗ of relative roll angle φᵣₑₗ using the measured lateral acceleration a_{ym}. In steady-state maneuvers the relative roll angle φᵣₑₗ is given by the product (−R_{gain}a_{ym}), where R_{gain} is the roll gain of vehicle 10 in radians of roll angle per 1 m/sec² of lateral acceleration. This relationship is also reasonably accurate during transient maneuvers except in cases where the roll mode of the vehicle is significantly under-damped. In those cases, the roll gain R_{gain} can be modified by a dynamic second order filter that models the vehicle's roll mode. For example, the filter may be of the form −R_{gain}b_{nf}²/(s²+2ζb_{nf}+b_{nf}²) where b_{nf} is the undamped natural frequency of the vehicle's roll mode and ζ is the damping ratio.

Blocks 52 and 54 then determine the total roll angle φₜₒₜ. First, block 52 determines the estimated total roll angle φₑₜₒₜ according to the sum of the estimated bank angle φ_{ebank} and the estimated relative roll angle θₑᵣₑₗ. Then block 54 determines a blended estimate φ_{ebl} of the total roll angle by blending φₑₜₒₜ with a roll angle determined by integrating the bias-compensated roll rate measurement ωₘ_{_{—}}_{cor}. To avoid explicitly integrating ωₘ_{_{—}}_{cor}, the terms ωₘ_{_{—}}_{cor}, φₑₜₒₜ and \dot{φ}_{ebl} can be combined with a blending factor b_{bl}_{_{—}}_{f} in a differential equation as follows:

\dot{φ}_{ebl}+b_{bl}_{_{—}}_{f}φ_{ebl}=b_{bl}_{_{—}}_{f}φₑₜₒₜ+φₘ_{_{—}}_{cor} (15)

Representing equation (15) in the Laplace domain, and solving for the blended roll angle estimate φ_{ebl} yields:

$${φ}_{ebl} = \frac{{b}_{bl \_ f}}{s + {b}_{bl \_ f}} {φ}_{etot} + \frac{1}{s + {b}_{bl \_ f}} {ω}_{m \_ cor} \qquad ( 16 )$$

which in practice is calculated on a discrete-time domain basis as follows:

φ_{ebl}(tᵢ₊₁)=(1−b_{bl}_{_{—}}_{f}Δt)[φ_{ebi}(tᵢ)+Δtωₘ_{_{—}}_{cor}(tᵢ₊₁)]+b_{bl}_{_{—}}_{f}Δtφₑₜₒₜ(tᵢ₊₁) (17)

where tᵢ₊₁ denotes the current value, tᵢ denotes a previous value, Δt is the sampling period, and the blending factor b_{bl}_{_{—}}_{f} is assigned a calibrated value, such as 0.244 rad/sec. If the roll angle obtained by integrating ωₘ_{_{—}}_{cor} is denoted by φ_{ω}, the blended roll angle estimate φ_{ebl} may be equivalently expressed as:

$${φ}_{ebl} = \frac{{b}_{bl \_ f}}{s + {b}_{bl \_ f}} {φ}_{etot} + \frac{s}{s + {b}_{bl \_ f}} {φ}_{ω} \qquad ( 18 )$$

In this form, it is evident that the blended roll angle estimate φ_{ebl} is a weighted sum of φₑₜₒₜ and φ_{ω}, with the weight dependent on the frequency of the signals (designated by the Laplace operand “s”) so that the blended estimate φ_{ebl} is always closer to the preliminary estimate that is most reliable at the moment. During steady-state conditions, the body roll rate is near-zero and the signal frequencies are also near-zero. Under such steady-state conditions, the coefficient of φₑₜₒₜ approaches one and the coefficient of φ_{ω} approaches zero, with the result that φₑₜₒₜ principally contributes to φ_{ebl}. During transient conditions, on the other hand, the body roll rate is significant, and the signal frequencies are high. Under such transient conditions, the coefficient of φₑₜₒₜ approaches zero and the coefficient of φ_{w} approaches one, with the result that φ_{w} principally contributes to φ_{ebl}.

Block 56 is then executed to compensate the measured lateral acceleration a_{ym} for the gravity component due to roll angle. The corrected lateral acceleration a_{ycor} is given by the sum (a_{ym}+g sin φ_{ebl}), where φ_{ebl} is the blended roll angle estimate determined at block 54. The corrected lateral acceleration a_{ycor} can be used in conjunction with other parameters such as roll rate and vehicle speed for detecting the onset of a rollover event.

Finally, block 58 is executed to use the blended roll angle estimate φ_{ebl} to estimate other useful parameters including the vehicle side slip (i.e., lateral) velocity v_{y} and side-slip angle β. The derivative of lateral velocity can alternately be expressed as (a_{y}−vₓΩ) or (a_{ym}+g sin φ−vₓΩ), where ay in the expression (a_{y}−vₓΩ) is the actual lateral acceleration, estimated above as corrected lateral acceleration a_{ycor}. Thus, the derivative of lateral velocity may be calculated using a_{ycor} for a_{y} in the expression (a_{y}−vₓΩ), or using the blended roll angle estimate φ_{ebl} for φ in the expression (a_{ym}+g sin φ−vₓΩ). Integrating either expression then yields a reasonably accurate estimate v_{ye} of side slip velocity v_{y}, which can be supplied to block 42 for use in the pitch angle calculation, as indicated by the broken flow line 60. And once the side-slip velocity estimate v_{ye} has been determined, the side-slip angle β at the vehicle's center of gravity is calculated as:

$$β = {tan}^{- 1} \frac{{v}_{ye}}{{v}_{x}} \qquad ( 19 )$$

In summary, the present invention provides a novel and useful way of accurately estimating the absolute roll angle of a vehicle body by blending under any vehicle operating condition. The preliminary roll angle estimates contributing to the blended roll angle are based on typically sensed parameters, including roll rate, lateral acceleration, yaw rate, vehicle speed, and optionally, steering angle and longitudinal acceleration. The preliminary roll angle estimate based on the measured roll rate is improved by initially compensating the roll rate signal for bias error using roll rate estimates inferred from other measured parameters. The other preliminary roll angle estimate is determined according to the sum of the road bank angle and the relative roll angle, with the bank angle being estimated based on the kinematic relationship among lateral acceleration, yaw rate and vehicle speed, and the relative roll angle being estimated based on lateral acceleration and the roll gain of the vehicle. The blended estimate of roll angle utilizes a blending factor that varies with the frequency of the preliminary roll angle signals so that the blended estimate continuously favors the more accurate of the preliminary roll angle estimates. The blended estimate is used to estimate the actual lateral acceleration, the lateral velocity and side-slip angle of the vehicle, all of which are useful in applications such as rollover detection and vehicle stability control.

While the present invention has been described with respect to the illustrated embodiment, it is recognized that numerous modifications and variations in addition to those mentioned herein will occur to those skilled in the art. For example, the preliminary estimate of relative roll angle φᵣₑₗ may be obtained from suspension deflection sensors instead of equation (3) if such sensors are available. Also, the lateral velocity may be determined using a model-based (i.e., observer) technique with the corrected lateral acceleration a_{ycor} as an input, instead of integrating the estimated derivative of lateral velocity. Finally, it is also possible to apply the blending method of this invention to estimation of absolute pitch angle θ in systems including a pitch rate sensor; in that case, a first preliminary pitch angle estimate would be obtained by integrating a bias-compensated measure of the pitch rate, and a second preliminary pitch angle estimate would be obtained from equation (8). Of course, other modifications and variations are also possible. Accordingly, it is intended that the invention not be limited to the disclosed embodiment, but that it have the full scope permitted by the language of the following claims.

1. A method of operation for a vehicle having a body that rolls about a longitudinal axis relative to a level ground plane, comprising the steps of:
determining a first preliminary estimate of a total roll angle of the vehicle body based on a signal produced by a roll rate sensor, said first preliminary estimate having an accuracy that is highest under transient conditions when a roll rate of the vehicle body is relatively high;
determining a second preliminary estimate of the total roll angle based on a sum of an estimated bank angle of a road surface supporting the vehicle with respect to the level ground plane and an estimated relative roll angle of the vehicle body with respect to the road surface, said second preliminary estimate having an accuracy that is highest under near steady-state conditions when the roll rate of the vehicle body is relatively low;
blending the first and second preliminary estimates of the total roll angle with blending coefficients to form a blended estimate of the total roll angle, where the blending coefficients are continuously variable according to a frequency of said first and second preliminary estimates so that the blended estimate favors the first preliminary estimate under the transient conditions and the second preliminary estimate under the near steady-state conditions; and
controlling a vehicle system based on the blended estimate of the total roll angle.

2. The method of claim 1, including the steps of:
determining a bias error in the signal produced by the roll rate sensor; and
removing the determined bias error from the signal produced by the roll rate sensor before determining said first preliminary estimate of the total roll angle.

3. The method of claim 2, where the step of determining the bias error in the signal produced by the roll rate sensor includes the steps of:
determining at least one auxiliary roll rate estimate based on sensed parameters other than the roll rate during the steady-state conditions;
determining a difference between the auxiliary roll rate estimate and the signal produced by the roll rate sensor;
limiting a magnitude of said difference to form a limited difference; and
determining said bias error by low-pass filtering said limited difference.

4. The method of claim 3, where the step of determining at least one auxiliary roll rate estimate includes the steps of:
determining a roll angle estimate based on sensed parameters other than the roll rate during the steady-state conditions; and
differentiating the determined roll angle estimate to form the auxiliary roll rate estimate.

5. The method of claim 1, including the steps of:
measuring a lateral acceleration of said vehicle body; and
determining the estimated relative roll angle of the vehicle body based on a product of the measured a lateral acceleration and a known roll gain of the vehicle.

6. The method of claim 1, including the steps of:
measuring a lateral acceleration and a yaw rate of said vehicle body;
estimating a longitudinal velocity of said vehicle; and
using the measured lateral acceleration and yaw rate and the estimated longitudinal velocity to determine a bank component of the measured lateral acceleration that is due to the bank angle; and
estimating the bank angle based on the determined bank component of the measured lateral acceleration.

7. The method of claim 6, including the steps of:
compensating the measured lateral acceleration for effects of the relative roll angle;
determining a difference between the compensated measured lateral acceleration and a product of the measured yaw rate and the estimated longitudinal velocity;
limiting a magnitude of said difference to form a limited difference; and
passing said limited difference through a low-pass filter to determine said bank component.

8. The method of claim 7, where said low-pass filter has a gain term that determines a rate at which said limited difference passes through said low pass filter, and the method includes the step of:
setting said gain term to a first value for passing said limited difference through said low pass filter at a high rate when a yaw motion of the vehicle body is relatively low, and otherwise setting said gain term to a second value for passing said limited difference through said low pass filter at a low rate.

9. The method of claim 1, including the steps of:
measuring a lateral acceleration of the vehicle body; and
compensating the measured lateral acceleration for a gravity component due to the blended estimate of the total roll angle; and
controlling the vehicle system based on compensated lateral acceleration.

10. The method of claim 1, including the steps of:
determining a lateral velocity of the vehicle body based on the blended estimate of the total roll angle; and
controlling the vehicle system based on determined lateral velocity.

11. The method of claim 10, including the steps of:
determining a pitch angle of the vehicle body based on the determined lateral velocity, measures of longitudinal acceleration and yaw rate of the vehicle body, and an estimated longitudinal velocity of the vehicle;
compensating the signal produced by the roll rate sensor due to the determined pitch angle; and
determining said first preliminary estimate of the total roll angle based on the compensated roll rate sensor signal.

12. The method of claim 10, including the step of:
determining a side-slip angle of the vehicle based on the determined lateral velocity and an estimate of a longitudinal velocity of the vehicle; and
controlling the vehicle system based on determined side-slip angle.
